(19) United States
(12) Patent Application Publication
(10) Pub. No.: US 2026/0064036 A1
(43) Pub. Date: Mar. 5, 2026

(54) IMAGE FORMING APPARATUS

(71) Applicant: CANON KABUSHIKI KAISHA, Tokyo (JP)

(72) Inventors: ISSEI IMAMURA, Shizuoka (JP); JIRO YAMADA, Kanagawa (JP); SHUN YAMASHITA, Shizuoka (JP); SHUICHI GOFUKU, Shizuoka (JP); TAKAYUKI YADA, Shizuoka (JP); SHINICHI AGATA, Shizuoka (JP)

(21) Appl. No.: 19/276,321

(22) Filed: Jul. 22, 2025

(30) Foreign Application Priority Data
Sep. 4, 2024 (JP) 2024-152752

(51) Int. Cl. G03G 15/08; G03G 15/00; G03G 15/06; G03G 21/18

(52) U.S. Cl. CPC G03G 15/0813; G03G 15/065; G03G 15/0808; G03G 15/5004; G03G 15/5008; G03G 21/1814; G03G 21/1857

(57) ABSTRACT

An image forming apparatus includes an image bearing roller, a developing roller, a supplying roller. In a first period when the developing roller is moved from a separated position to a contacting position, peripheral speeds of the image bearing roller, developing roller and supplying roller are Vo1, Vd1 and Vr1, respectively, and in a second period while the electrostatic latent image is being formed on the image bearing roller, a peripheral speed of the image bearing roller, developing roller and supplying roller are Vo2, Vd2 and Vr2. A controller controls so as to satisfy a following relationship,

|Vo1−Vd1|<|Vo2−Vd2|, |Vd1-Vr1|<|Vd2−Vr2|, and

to monotonically change the peripheral speeds of the image bearing roller, developing roller and supplying roller from Vo1 to Vo2, from Vd1 to Vd2, and from Vr1 to Vr2.

### BACKGROUND

### Field of the Technology

The present invention relates to an image forming apparatus, and relates to the image forming apparatus, for example, such as a copy machine, a printer and a facsimile device using an electrophotographic type or an electrostatic recording type.

### Description of the Related Art

An image forming apparatus of an electrophotographic type includes an image forming process including a step in which a surface of a photosensitive drum as an image bearing member is uniformly charged to a predetermined polarity and potential, a step in which an electrostatic latent image is formed on the charged surface, and a step in which the electrostatic latent image is developed by toner as developer. And as a development type which performs the development of the electrostatic latent image formed on the photosensitive drum, a contact development type, which performs the development by bringing a developing roller as a developer carrying member into contact with the photosensitive drum, is generally used.

The contact development type includes, in order to prevent deformation of the developing roller having elasticity, a contacting and separating mechanism between the developing roller and the photosensitive drum in a contacting portion between the developing roller and the photosensitive drum. The contacting and separating mechanism is a structure which brings the photosensitive drum and the developing roller into contact with each other during image formation and separates the photosensitive drum and the developing roller during periods other than the image formation. In the image forming apparatus provided with the contacting and separating mechanism, for example, in Japanese Patent Application Laid-Open No. 2006-085127, in order to reduce that shock jitter occurs in an image caused by the photosensitive drum being vibrated due to shock upon the contact, the photosensitive drum and the developing roller are brought into contact with each other with setting a peripheral speed of the photosensitive drum to a low speed. A configuration which absorbs the shock upon the contact in this manner is proposed. In addition, for example, in Japanese Patent Application Laid-Open No. H05-107902, upon the contact between the photosensitive drum and the developing roller with different peripheral speeds, in order to prevent image disturbance caused by rotational unevenness due to load fluctuation in the photosensitive drum occurring, the peripheral speeds of the photosensitive drum and the developing roller are set to the same upon the contact. A configuration which reduces rotational unevenness in this manner is proposed.

### SUMMARY

In order to solve the aforementioned problems, the present invention includes the following configuration.
(1) An image forming apparatus comprising: a rotatable image bearing member on which an electrostatic latent image is formed; a rotatable developing member configured to supply a developer to the image bearing member, develop the electrostatic latent image and form a developer image; a rotatable supplying member configured to supply the developer to the developing member by contacting the developing member; a moving portion configured to move the developing member to a contacting position where the developing member is contacted to a surface of the image bearing member or a separated position where the developing member is separated from the surface of the image bearing member; a driving source configured to drive the image bearing member, the developing member and the supplying member; and a control means configured to control the moving portion and the driving source, wherein in a first period when the developing member is moved from the separated position to the contacting position by the moving portion before the electrostatic latent image is formed on the image bearing member, when a peripheral speed that is a moving speed of the surface of the image bearing member is defined as Vo1, a peripheral speed that is a moving speed of a surface of the developing member is defined as Vd1, a peripheral speed that is a moving speed of a surface of the supplying member is defined as Vr1, an absolute value of a difference between the peripheral speed of the image bearing member and the peripheral speed of the developing member is defined as |Vo1−Vd1|, and an absolute value of a difference between the peripheral speed of the developing member and the peripheral speed of the supplying member is defined as |Vd1−Vr1|, and in a second period while the electrostatic latent image is being formed on the image bearing member, when a peripheral speed that is a moving speed of the surface of the image bearing member is defined as Vo2, a peripheral speed that is a moving speed of the surface of the developing member is defined as Vd2, a peripheral speed that is a moving speed of the surface of the supplying member is defined as Vr2, an absolute value of a difference between the peripheral speed of the image bearing member and the peripheral speed of the developing member is defined as |Vo2−Vd2|, and an absolute value of a difference between the peripheral speed of the developing member and the peripheral speed of the supplying member is defined as |Vd2−Vr2|, the control means controls the driving source so as to satisfy a following relationship,

$$\begin{matrix}\vert V o 1 - V d 1 \vert < \vert V o 2 - V d 2 \vert , and \\ \vert V d 1 - V r 1 \vert < \vert V d 2 - V r 2 \vert , and\end{matrix}$$

so as to monotonically change the peripheral speed that is the moving speed of the surface of the image bearing member from Vo1 to Vo2, the peripheral speed that is the moving speed of the surface of the developing member from Vd1 to Vd2, and the peripheral speed that is the moving speed of the surface of the supplying member from Vr1 to Vr2.

Further features of the present invention will become apparent from the following description of exemplary embodiments with reference to the attached drawings.

### BRIEF DESCRIPTION OF THE DRAWINGS

FIG. 1 is a view illustrating an image forming apparatus in Embodiments 1 and 2.

FIG. 2 is a block diagram illustrating a control configuration of the image forming apparatus in the Embodiments 1 and 2.

FIG. 3 is a view illustrating a process cartridge in the Embodiments 1 and 2.

FIG. 4 includes timing charts of a contact and a separation and peripheral speeds of each member in the Embodiment 1.

FIG. 5 includes timing charts of the contact and the separation and the peripheral speeds of each member in a Comparative Example 1 to the Embodiment 1.

FIG. 6, part (a) and part (b), includes views illustrating unevenness containing toner in a supplying roller upon the contact and the separation in the Embodiment 1.

FIG. 7 is a view illustrating torque fluctuation of a developing roller in the Embodiment 1.

FIG. 8 includes timing charts of a contact and a separation, a developing voltage and a supplying voltage in the Embodiment 2.

### DESCRIPTION OF THE EMBODIMENTS

Hereinafter, with reference to the drawings, suitable Embodiments for the present invention will be described in detail by way of example. However, dimensions, material, shapes and relative arrangement of constituting components described in the Embodiments are, unless otherwise noted in particular, not intended to limit the scope of the present invention only thereto. In addition, as for material, shapes, etc. of a member described once in the description below, unless otherwise described anew in particular, those are the same as the first description also in the later description.

### Embodiment 1

### <Outline of a Configuration of an Image Forming Apparatus>

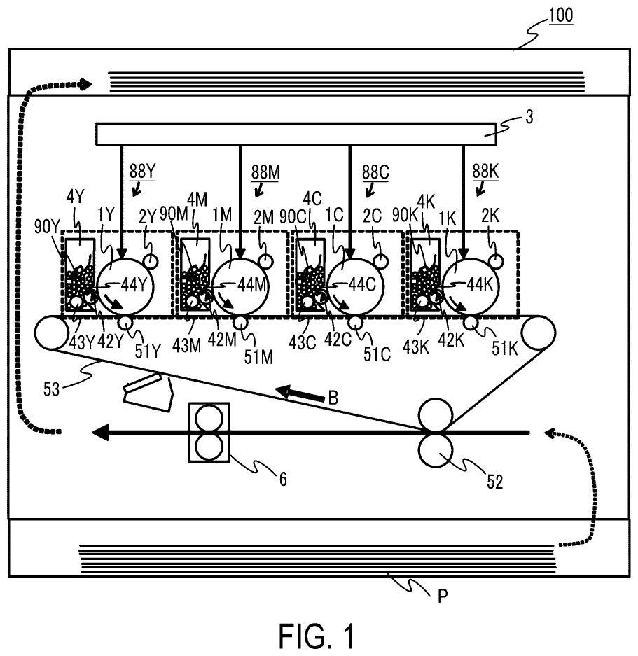

With reference to FIG. 1, an operation of an image forming apparatus 100 in an Embodiment 1 will be described. FIG. 1 is a cross-sectional outline view of the image forming apparatus 100 provided with a process cartridge 88 in the Embodiment 1. The image forming apparatus 100 in the Embodiment 1 is a full-color laser beam printer which employs an in-line type and an intermediary transfer type. The image forming apparatus 100 can form, according to image information, a full-color image on a transfer material P as a transferred material (for example, a recording sheet, a plastic sheet, cloth, etc.). The image information is input to a main assembly of the image forming apparatus 100 from an image reading apparatus connected to the main assembly of the image forming apparatus 100 or a host device such as a personal computer communicably connected to the main assembly of the image forming apparatus 100.

In the image forming apparatus 100, in FIG. 1, from left side to right side, image forming stations (hereinafter, also referred to as image forming portions) of four colors of yellow, magenta, cyan and black are provided side by side. Each image forming portion is an electrophotographic image forming mechanism of the same configuration as each other, except that colors of toner 90 as developer accommodated in respective developing devices 4 are different. Incidentally, in description below, in a case in which distinction is not necessary in particular, subscripts Y (yellow), M (magenta), C (cyan) and K (black), which are given to reference numerals in order to indicate that an element is provided for one of the colors, will be omitted and the elements will be described collectively.

The process cartridge 88 is configured, via a mounting means such as a mounting guide and a positioning member provided in the main assembly of the image forming apparatus 100, to be mountable to and demountable from the image forming apparatus 100. In the Embodiment 1, all of the process cartridges 88 for each color have the same shape, and in the process cartridges 88 for each color, the toner for each color of Y (yellow), M (magenta), C (cyan) and K (black) is accommodated. The process cartridge 88 includes a developing device 4, and the developing device 4 includes a developing roller 42, a supplying roller 43 and a regulating blade 44.

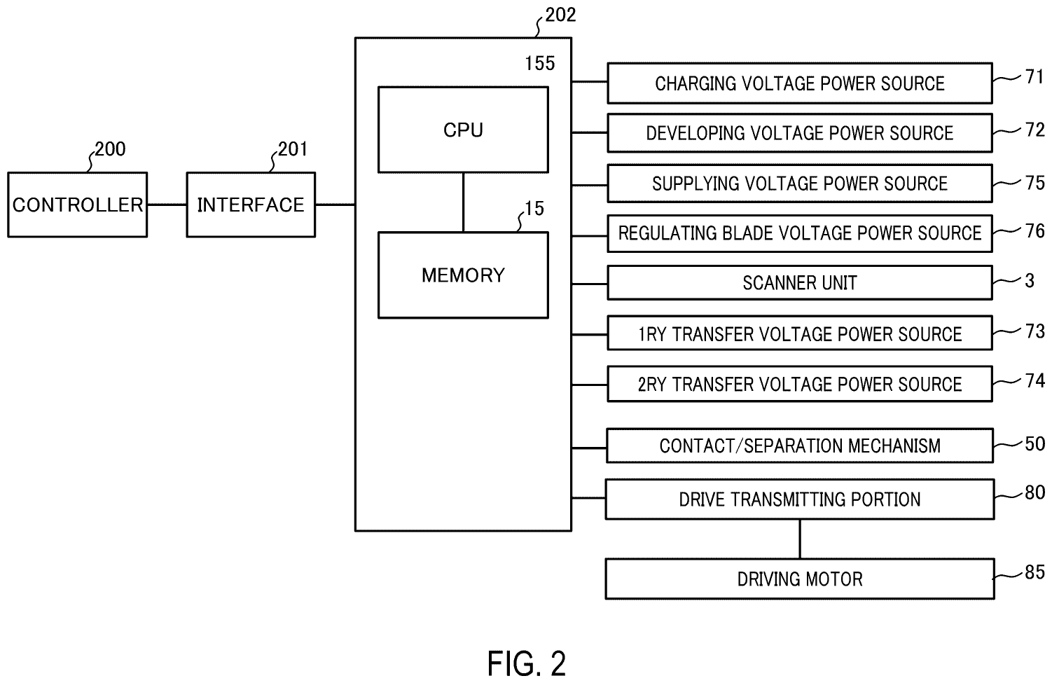

A photosensitive drum 1 as an image bearing member is rotationally driven by a driving motor 85 (see FIG. 2). A charging roller 2 uniformly charges a surface of the photosensitive drum 1. In a periphery of the photosensitive drum 1, a scanner unit 3 is disposed. The scanner unit 3 is an exposure means which forms an electrostatic latent image on the photosensitive drum 1 by irradiating a laser based on an image signal. Opposing to the four photosensitive drums 1, an intermediary transfer belt 53 as an intermediary transfer member for transferring toner images (developer images) on the photosensitive drums 1 to the transfer material P is disposed. The intermediary transfer belt 53, which is formed by an endless belt, is in contact with all of the photosensitive drums 1, and is circularly moved (rotated) in a direction of an arrow B in the figure.

On an inner peripheral surface side of the intermediary transfer belt 53, so as to oppose each photosensitive drum 1, as primary transfer means, four primary transfer rollers 51Y, 51M, 51C and 51K are provided side by side. And to the primary transfer rollers 51, from a primary transfer voltage power source 73 (see FIG. 2) as a primary transfer voltage applying means, voltage of reverse polarity to normal charging polarity of the toner is applied. As a result, the toner image on the photosensitive drum 1 is transferred (primarily transferred) onto the intermediary transfer belt 53. A portion at which the toner image is transferred from the photosensitive drum 1 to the intermediary transfer belt 53 is referred to as a primary transfer portion.

In addition, on an outer peripheral surface side of the intermediary transfer belt 53, a secondary transfer roller 52 (transfer member) as a secondary transfer means is disposed. And to the secondary transfer roller 52, from a secondary transfer voltage power source 74 (see FIG. 2) as a secondary transfer voltage applying means, voltage of the reverse polarity to the normal charging polarity of the toner is applied. As a result, the toner image on the intermediary transfer belt 53 is transferred (secondarily transferred) to the transfer material P. A portion at which the toner image is transferred from the intermediary transfer belt 53 to the transfer material P is referred to as a secondary transfer portion. For example, during formation of the full-color image, the process described above is performed sequentially in the image forming portions Y, M, C and K, and the toner images of each color are sequentially superimposed and primarily transferred on the intermediary transfer belt 53. Thereafter, the transfer material P is conveyed to the secondary transfer portion in synchronization with a move of the intermediary transfer belt 53. And by an action of the secondary transfer roller 52, which is in contact with the intermediary transfer belt 53 via the transfer material P, the toner images of the four colors on the intermediary transfer belt 53 are secondarily transferred onto the transfer material P at once. The transfer material P, onto which an unfixed toner image is transferred, is conveyed to a fixing device 6 as a fixing means. By heat and pressure being applied to the transfer material P in the fixing device 6, the toner image is fixed to the transfer material P, and the transfer material P is discharged outside the image forming apparatus 100 as an image formed product.

### <Control of the Image Forming Apparatus>

FIG. 2 is a block diagram illustrating an outline control mode of a main portion of the image forming apparatus 100 in the Embodiment 1. A control portion 202 is a means which controls the operation of the image forming apparatus 100, and sends and receives various types of electrical information signals. In addition, the control portion 202 performs processing of the electrical information signals input from various types of process devices and sensors and processing of command signals to the various types of the process devices. A controller 200 sends and receives various types of electrical information to and from the host device, and collectively controls the image forming operation of the image forming apparatus 100 according to predetermined control programs and reference tables with the control portion 202 via an interface 201.

The control portion 202 as a control means includes a CPU 155, which is a central element performing various arithmetic processing, a memory 15 such as a RAM and a ROM, which are storage elements, etc. In the RAM, a detection result of the sensor, a counting result of a counter, a calculation result, etc. are stored, and in the ROM, a control program, a data table obtained through an experiment in advance, etc. are stored. To the control portion 202, each control target, the sensor, the counter, etc. in the image forming apparatus 100 are connected. The control portion 202 performs control of a predetermined image forming sequence, etc. by controlling sending and receiving of the various types of the electrical information signals, timings of driving of each portion, etc.

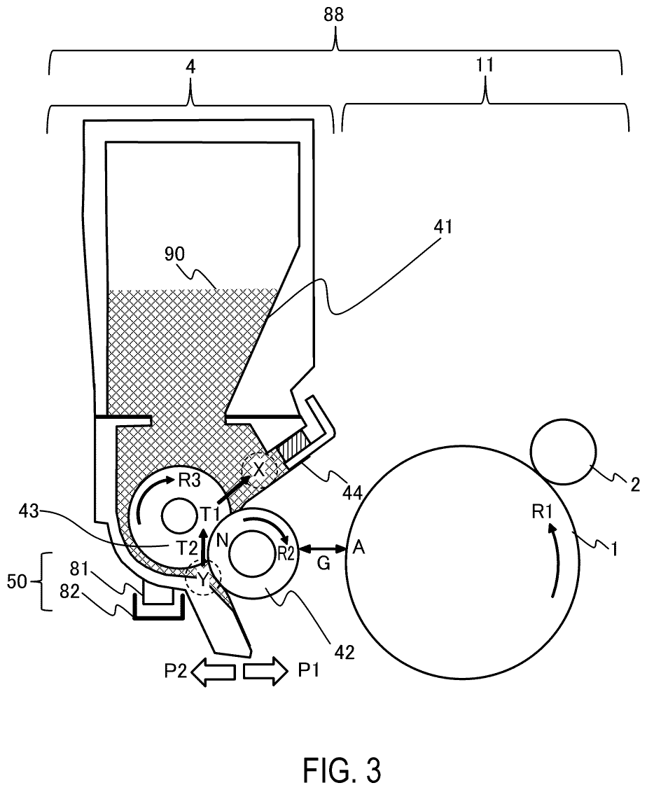

The control portion 202 controls, for example, following high voltage power sources and devices in order to form the toner images on the surface of the photosensitive drum 1. Specifically, the control portion 202 performs control of a charging voltage power source 71, a developing voltage power source 72, a supplying voltage power source 75, a regulating blade voltage power source 76, the scanner unit 3, etc. Here, the charging voltage power source 71 is a charging voltage applying means which applies a charging voltage to the charging roller 2. The developing voltage power source 72 is a developing voltage applying means which applies a developing voltage to the developing roller 42. The supplying voltage power source 75 is a supplying voltage applying means which applies a supplying voltage to the supplying roller 43. The regulating blade 44 is a toner regulating member, and the regulating blade voltage power source 76 is a power source for the regulating blade 44. Furthermore, the control portion 202 performs control of a primary transfer voltage power source 73, a secondary transfer voltage power source 74, etc. The control portion 202 performs, other than these, control of a contacting and separating mechanism 50, which performs contact and separation between the photosensitive drum 1 and the developing roller 42, and a drive transmitting portion 80, which performs rotational drive of a drum unit 11 (see FIG. 3) and the developing device 4. The drive transmitting portion 80 transmits driving force of the driving motor 85 to the drum unit 11 and the developing device 4. The photosensitive drum 1, the developing roller 42 and the supplying roller 43 are rotated by the driving force of the driving motor 85.

### <Outline of a Configuration of the Process Cartridge>

An overall configuration of the process cartridge 88 which is mounted to the image forming apparatus 100 in the Embodiment 1 will be described. In the Embodiment 1, the drum unit 11 and the developing device 4 are integrated as the process cartridge 88. FIG. 3 is a main cross-sectional view of the process cartridge 88 in the Embodiment 1 as viewed along a longitudinal direction (rotational axis direction) of the photosensitive drum 1. Incidentally, in the Embodiment 1, except for types (the colors) of the toner accommodated therein, the configurations and operations of the process cartridges 88 for each color are substantially the same.

To the process cartridge 88, rotational driving force of the driving motor 85 is transmitted from a drive output portion (not shown) of the imaging forming apparatus 100, and voltages (the charging voltage, the developing voltage, the supplying voltage, the regulating blade voltage, etc.) are supplied from a contact point with the image forming apparatus 100. The drum unit 11 is provided with the photosensitive drum 1 and the charging roller 2 which is a charging member.

The photosensitive drum 1 is a rotatable cylindrical photosensitive member, and at one end side in the longitudinal direction of the photosensitive drum 1, an unshown coupling member for transmitting the driving force to the photosensitive drum 1 is provided. The coupling member engages with a drum drive coupling on the image forming apparatus side as a drum drive output portion of the image forming apparatus 100, and the driving force of the driving motor 85 of the image forming apparatus 100 is transmitted to the photosensitive drum 1. The photosensitive drum 1 is rotated in a direction of an arrow R1 (counterclockwise direction) in FIG. 3, which is a first direction, about a rotational axis thereof. In the Embodiment 1, at a full speed, the photosensitive drum 1 is rotationally driven at a rotation speed such that a speed of an outer peripheral surface (peripheral speed) of the photosensitive drum 1 is 148 mm/sec.

In addition, the surface of the photosensitive drum 1 is uniformly charged by the charging roller 2. In the Embodiment 1, the charging roller 2 is an electroconductive roller, in which an electroconductive rubber layer is provided on a core metal thereof, is disposed in parallel with and in contact at predetermined pressure with the photosensitive drum 1, and is rotated following the rotation of the photosensitive drum 1. Furthermore, to the charging roller 2, the charging voltage can be applied from the charging voltage power source 71. In the Embodiment 1, to the charging roller 2, for example, by applying a direct current voltage of −1350 V, the photosensitive drum 1 is charged, and surface potential of the photosensitive drum 1 at that time becomes approximately −700 V. It is set so that the surface potential (light portion potential) of the photosensitive drum 1 after the exposure in the Embodiment 1 becomes −150 V.

The developing device 4 contains the toner 90, for example, whose normal charging polarity (charging polarity for developing the electrostatic latent image) is negative. At one end side in a longitudinal direction of the developing device 4, a development drive input gear (not shown) for transmitting the driving force to the developing device 4 is provided. To the development drive input gear, a development input coupling portion (not shown) which receives the drive from a development drive coupling on the image forming apparatus side (not shown) of the image forming apparatus 100 is provided, and the driving force of the driving motor 85 of the image forming apparatus 100 is input to the developing device 4. To the developing device 4, the rotatable developing roller 42 (developing member), which is a developer carrying member, the rotatable supplying roller 43 (supplying member), which is a developer supplying member, and the regulating blade 44, which is a developer regulating member, are provided. The gears and the couplings described above are included in the drive transmitting portion 80.

The toner 90 is supplied to a surface of developing roller 42 by the supplying roller 43. And the toner 90 held on the developing roller 42 is regulated by the regulating blade 44 in a thickness of a layer thereof (hereinafter, referred to as a layer thickness), and is made into a thin layer. Here, the regulating blade 44 has a function regulating the layer thickness of the toner 90 on the developing roller 42, and has a function as a developer charging means which applies a predetermined electric charge to the toner 90 on the developing roller 42. The toner 90 which has been made into the thin layer is conveyed to a contact portion with the photosensitive drum 1 along with the rotation of the developing roller 42, the toner 90 is applied to the surface of the photosensitive drum 1, and the electrostatic latent image formed on the photosensitive drum 1 is developed by the toner 90. In addition, the toner 90 remaining on the developing roller 42 without being supplied to the development is removed from the developing roller 42 in a contact portion with the supplying roller 43. And the removed toner 90 is agitated and mixed with the toner 90 in the developing device 4.

The developing roller 42 is a roller in which an electroconductive elastic rubber layer having a predetermined volume resistivity is provided on an outer periphery of a metallic core metal thereof, and is configured so that a surface thereof has a predetermined surface roughness. For the developing roller 42, a single-layer roller or a roller with multi-layer structure can be used. As the single-layer roller, for example, a roller in which an elastic layer is formed on a core metal thereof by rubber material such as silicone rubber, urethane rubber and hydrin rubber can be used. As the roller with multi-layer structure, for example, a roller in which a surface layer is formed by applying silicone resin, urethane resin, polyamide resin, fluorine resin, etc. to a surface of the elastic layer can be used.

The supplying roller 43 is an elastic sponge roller in which a layer (hereinafter, also referred to as a foam member layer or a foam layer) is formed by an electroconductive foam member on an outer periphery of a metallic core metal thereof. On a surface of this foam layer, foam cells are opening, which facilitate retention and conveyance of the toner 90. The supplying roller 43 is disposed so as to contact the developing roller 42 with a predetermined penetrating amount, and forms a nip portion N. In the nip portion N, the supplying roller 43 is deformed in a concave shape by the developing roller 42. The supplying roller 43 is rotated in a direction of an arrow R3 in FIG. 3 so as to be an opposite direction to a rotational direction of the developing roller 42 in the nip portion N with the developing roller 42, and supplies the toner 90 to the developing roller 42. In other words, the rotational direction of the supplying roller 43 (R3) is the same direction (a second direction) as the rotational direction of the developing roller 42 (R2), and is an opposite direction to the rotational direction of the photosensitive drum 1 (R1).

In addition, the supplying roller 43 scrapes off the toner 90 on the developing roller 42, which remains without being used for the development of the electrostatic latent image on the photosensitive drum 1, with the openings in the foam layer included in the surface thereof, and returns the toner 90 back to an inside of a developing container 41. The foam layer of the supplying roller 43 is deformed just before the nip portion N with the developing roller 42, and the deformation causes the toner 90 which has been stayed on the surface of and inside the foam layer to be discharged into an area X in a direction of an arrow T1. Upon the deformation being recovered by the foam layer on the surface of the supplying roller 43 passing through the nip portion N, the toner 90 in an area Y is absorbed in a direction of an arrow T2.

In the Embodiment 1, for the supplying roller 43, a roller which includes a urethane foam layer and contains an ionic conductive agent is used. As an example, the supplying roller 43 in the Embodiment 1 has a structure in which an ionic conductive agent, which is constituted by a salt of cation having a reactive functional group which reacts with an isocyanate group and anion, is chemically bonded to the urethane foam layer via the above reactive functional group. For example, by foam curing the urethane composition containing the ion conductive agent, the supplying roller 43 having such a structure can be produced.

The driving force of the driving motor 85 input to the developing device 4 can rotate the developing roller 42 in the direction of the arrow R2 in FIG. 3 by being transmitted to a developing roller gear (not shown). In addition, the driving force of the driving motor 85 input to the developing device 4 can rotate the supplying roller 43 in the direction of the arrow R3 in FIG. 3 by being transmitted to a supplying roller gear (not shown). In the Embodiment 1, in order to obtain appropriate image density, it is desirable that a moving speed of the surface (hereinafter, also referred to as a peripheral speed) of the developing roller 42 is set to a ratio of the peripheral speed (hereinafter, referred to as a peripheral speed ratio) between 1.2 and 1.5 times to a moving speed of the surface of the photosensitive drum 1. In the Embodiment 1, the developing roller 42 is set to the peripheral speed ratio of 1.4 times for a balance between density and durability, and is rotationally driven at the moving speed, which becomes 207 mm/sec at a full speed, in the direction of the arrow R2.

In addition, for a balance between the supply and the scraping of the toner 90 to and from the developing roller 42, it is desirable for the supplying roller 43 to be set from 0.85 to 0.95 times to the moving speed of the surface of the developing roller 42. In the Embodiment 1, the peripheral speed ratio thereof is set to 0.9 times in consideration of durability, and the supplying roller 43 is rotationally driven at the speed, which becomes 186 mm/sec at a full speed, in the direction of the arrow R3.

The regulating blade 44 includes an elastic member having a plate shape, which has conductivity and flexibility. And the elasticity member is fixed to the developing container (frame member) at one end thereof and supported cantileveredly, so that the other end becomes a free end and is in contact with the peripheral surface of the developing roller 42. In addition, the regulating blade 44 is disposed, at a position on a more downstream side in the moving direction (rotational direction) of the surface of the developing roller 42 than the opposing portion (contact portion) between the supplying roller 43 and the developing roller 42, in a contacting state on the peripheral surface of the developing roller 42. In the Embodiment 1, SUS material is used as the elastic member of the regulating blade 44. In addition, in the Embodiment 1, the regulating blade 44 is provided, at the contact position with the developing roller 42, so that a tip portion on the free end side of the elastic member is in a state facing the upstream side (a counter direction) in the moving direction of the surface of the developing roller 42.

In addition, to the developing roller 42, the supplying roller 43 and the regulating blade 44, predetermined direct current voltages are applied from the developing voltage power source 72, the supplying voltage power source 75, and the regulating blade voltage power source 76 (see FIG. 2), respectively, according to the image forming operation, etc. In the Embodiment 1, during image formation, the direct current voltage of −450 V is applied to the developing roller 42, −550 V to the supplying roller 43, and −550 V to the regulating blade 44. In the Embodiment 1, since the normal charging polarity of the toner 90 is negative, a potential difference between the supplying roller 43 and the developing roller 42 becomes polarity with which the toner 90 is urged (moved) from the supplying roller 43 side to the developing roller 42 side.

In the Embodiment 1, for the toner 90, non-magnetic toner with a negative chargeability manufactured through a suspension polymerization method is used. For the toner 90, however, it is not limited thereto but may be, for example, toner manufactured by using other polymerization methods such as a pulverization method and an emulsion polymerization method. In addition, it is preferable for a volume-average particle diameter of the toner 90 to be 5.0-8.0 μm. Here, the volume-average particle diameter of the toner 90 is measured by a precision particle size distribution measuring device Multisizer 3 manufactured by Beckman Coulter Inc. In the Embodiment 1, the volume-average particle diameter of the toner 90 is about 7.0 μm.

In addition, in order to improve flowability, chargeability, cleanability, etc., a fluidizing agent, etc., which are additives (hereinafter, external additives), may be added to the toner 90. Examples of the external additives include inorganic oxide fine particles constituted by silica fine particles, alumina fine particles, titanium oxide fine particles, etc., inorganic stearate compound fine particles such as aluminum stearate fine particles and zinc stearate fine particles and inorganic titanate compound fine particles such as strontium titanate and zinc titanate. These external additives can be used with one type alone or with combining two or more types. It is preferable that a gloss process be performed to these inorganic fine particles by silane coupling agents, titanium coupling agents, higher fatty acids, silicone oils, etc. to improve heat storage resistance and environmental stability. In addition, a BET specific surface area of the external additives is preferably 10 m²/g or more and 450 m²/g or less.

The BET specific surface area can be measured by a low temperature gas adsorption method using a dynamic constant pressure method according to a BET method (preferably a BET multi-point method). For example, the BET specific surface area (m²/g) can be calculated by using a specific surface area measuring device (trade name: Gemini 2375 Ver. 5.0, manufactured by Shimadzu Corporation) to make sample surfaces adsorb nitrogen gas and measuring using the BET multi-point method. For amounts of these various kinds of the external additives, a total thereof is set to, with respect to 100 parts by mass of the toner, 0.05 parts by mass or more and 5 parts by mass or less, or preferably 0.1 parts by mass or more and 3 parts by mass or less. In addition, for the external additives, various kinds thereof may be combined and used.

In addition, residual toner which has not been transferred by the intermediary transfer belt 53 is present not a little on the photosensitive drum 1. In the image forming apparatus 100 in the Embodiment 1, such residual toner is charged, by electric discharge from the charging roller 2, to negative polarity which is the normal polarity (normal charging polarity) of the toner 90. The charged residual toner rushes into the charging portion, which is a contact portion between the charging roller 2 and the photosensitive drum 1. At this time, in the charging portion, the residual toner, for being negatively charged by the electric discharge by the charging roller 2, passes through the charging portion in a state in which the residual toner stays electrostatically on the photosensitive drum 1. Then, the residual toner which has passed through the charging portion is moved to a developing portion, which is the contact portion between the developing roller 42 and the photosensitive drum 1. In this developing portion, in a case in which the surface of the photosensitive drum 1, to which the residual toner is adhered, is a non-image forming portion (dark portion potential forming area), due to relationship between the potential of the photosensitive drum 1 and the developing roller 42, the toner is collected from the surface of the photosensitive drum 1 to the developing roller 42. In other words, the residual toner of negative polarity is collected by a potential difference of 350 V between −700 V, which is dark portion potential of the photosensitive drum 1, and −350 V, which is developing voltage potential. A larger potential difference improves collectability, however, the potential difference is determined in consideration of the latent image formation and developing performance during image formation. In addition, developer collectability also varies depending on a difference in the moving speeds of the surfaces of the photosensitive drum 1 and the developing roller 42 (hereinafter, referred to as a surface moving speed difference) and the larger moving speed of the surface improves the developer collectability. On the other hand, in a case in which the surface of the photosensitive drum 1, to which the residual toner is adhered, is an image forming portion (light portion potential forming area), the residual toner keeps remaining on the surface of the photosensitive drum 1 and is used as the toner 90 to form an image.

The system in which the residual toner is collected by the developing roller 42 is a so-called cleanerless type. Since the drum unit 11 of the cleanerless type has a configuration only of the photosensitive drum 1, of which an inside has a hollow structure and which is lightweight, and the charging roller 2, which is rotated by following the rotation of the photosensitive drum 1, load torque during rotational drive is extremely small. Therefore, in the Embodiment 1, the drum unit 11 and the developing device 4 are driven by the driving motor 85, which is the same driving source, and by minimizing a number of driving sources, a size of the image forming apparatus 100 is reduced.

### <Configuration and Operation of the Contacting and Separating Mechanism>

In the Embodiment 1, in order to avoid unnecessary contact between the photosensitive drum 1 and the developing roller 42 during a period in which the image formation is not performed (hereinafter, referred to as in non-image formation or during non-image formation), the following control is performed. That is, the control portion 202 controls a presence or absence of the contact between the photosensitive drum 1 and the developing roller 42 (development contact and separation operation) with the contacting and separating mechanism 50. The developing roller 42 is in contact (hereinafter, referred to as a development contact) with the surface of the photosensitive drum 1 at a contacting position A during image formation, and during non-image formation, except during continuous image formation, is moved to a separated position which is separated (hereinafter, referred to as a development separation) with keeping a predetermined distance G from the surface of the photosensitive drum 1. Incidentally, FIG. 3 illustrates a state of the development separation in which the developing roller 42 is moved to the separated position.

Next, a configuration and operation of the contacting and separating mechanism 50 as a moving portion will be described. The contacting and separating mechanism 50 includes a lever 81 as an action receiving portion, which is provided to the developing device 4, and a moving member 82 as an acting portion, which is provided to the main assembly of the image forming apparatus 100. In addition, the developing device 4 is connected, so as to be swingable about a rotational axis, which is approximately parallel to the rotational axis direction of the photosensitive drum 1, to a frame member which fixes a position of the photosensitive drum 1. By moving the lever 81 by operating the moving member 82, the developing device 4 is swung and moved between the contacting position and the separated position.

A move of the developing device 4 to the contacting position is performed by spring urging force by an extension spring (not shown) and rotation moment centered on driving input to the developing device 4 during driving of the developing device 4. Here, the extension spring functions as an urging means of which both ends are attached to the frame member, which fixes the position of the photosensitive drum 1, and the developing device 4. By the control portion 202 causing to move the moving member 82 of the contacting and separating mechanism 50 in a direction of an arrow P1 in FIG. 3, in interrelation with a move of the lever 81, a state in which the developing device 4 is held at the separated position is released. Then, by the spring urging force and the rotation moment, the developing device 4 is swung, and the developing roller 42 is moved to the photosensitive drum 1 side. By this, it is possible to move the developing device 4 to the contacting position, and to bring the developing roller 42 into a contacting state with respect to the photosensitive drum 1.

Conversely, in order to move the developing device 4 to the separated position, the control portion 202 causes to move the moving member 82 of the contacting and separating mechanism 50 to a side away from the photosensitive drum 1, which is a direction of an arrow P2, and to move the lever 81 in the same direction, to realize a state in which the developing device 4 is held at the separated position. By this, it is possible to move the developing device 4 to the separated position, and to bring the developing roller 42 into a separated state with respect to the photosensitive drum 1. Incidentally, a move of the moving member 82 is performed by receiving driving force from a motor or a solenoid as a driving source, which is provided to the image forming apparatus 100, via a drive transmitting member.

In the Embodiment 1, during image formation, the developing device 4 is disposed at the contacting position, and the developing roller 42 is set into the contacting state with respect to the photosensitive drum 1. In addition, other than during image formation such as in a standby state, a sleep state and a power off state, the developing device 4 is disposed at the separated position, and the developing roller 42 is set to the separated state with respect to the photosensitive drum 1. As such, by bringing the developing roller 42 into contact with the photosensitive drum 1 only when necessary, it is possible to prevent deformation of the developing roller 42 having elasticity and maintain performance thereof for a long period of time.

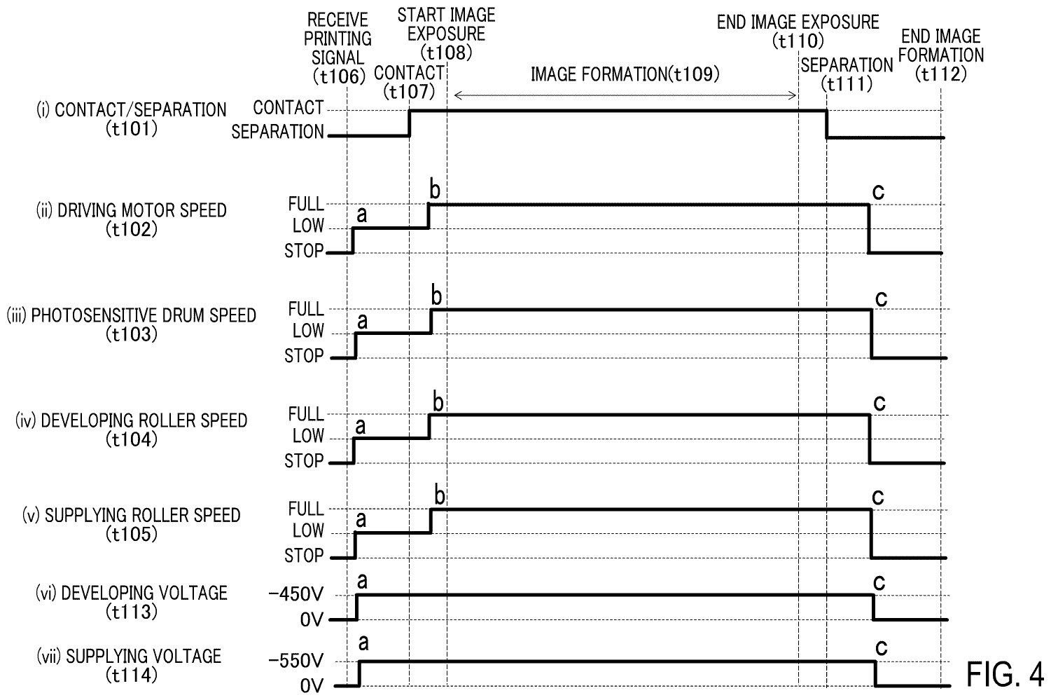

FIG. 4 includes timing charts of the contact and the separation and peripheral speeds of each member in the Embodiment 1. In FIG. 4, (i) shows the contact and separation (the contacting or the separated) state t101 of the developing roller 42, and (ii) shows a speed of the driving motor 85 (driving motor speed t102) (full speed, low speed, stop). (iii) shows the moving speed of the surface of the photosensitive drum 1 (a photosensitive drum speed t103) (full speed, low speed, stop), and (iv) shows the moving speed of the surface of the developing roller 42 (a developing roller speed t104) (full speed, low speed, stop). (v) shows the moving speed of the surface of the supplying roller 43 (a supplying roller speed t105) (full speed, low speed, stop). (vi) shows a developing voltage t113 (0 V, −450 V), and (vii) shows a supplying voltage t114 (0 V, −550 V). In addition, “a” through “c” in t102 through t105, “a” and “c” in t113, t114, t106 through t108, and t110 through t112 represent respective timings, and t109 represents a period.

In the Embodiment 1, in order to prevent a widthwise streak, which is generated at a rotation cycle of the supplying roller 43 (hereinafter, referred to as a supplying roller cycle) caused by the development contact during full speed print, the control portion 202 performs the following control. As shown in the timing chart in FIG. 4, after receiving a print signal at t106, the control portion 202 drives the driving motor speed t102 at low speed (t102a) with the contact and separation t101 being the separated state. As a result, the peripheral speeds of the photosensitive drum speed t103a, the developing roller speed t104a, and the supplying roller speed t105a are uniformly reduced. Therefore, upon the contact of the developing roller 42 at the timing t107, the photosensitive drum 1, the developing roller 42 and the supplying roller 43 are all driven at the lower speeds than during image formation at the full speeds, respectively. It is configured that the peripheral speed of the photosensitive drum 1 is 49 mm/sec, the peripheral speed of the developing roller 42 is 69 mm/sec, and the peripheral speed of the supplying roller 43 is 62 mm/sec.

### (on a Full Speed Mode and a Low Speed Mode)

The image forming apparatus 100 in the Embodiment 1 is capable of operating in a plurality of modes with different image forming speeds for performing the image formation. It is configured that the image forming apparatus 100 performs the image formation in a low speed mode in a case of printing to a thick paper, etc. in order to improve fixing performance, and performs the image formation in a full speed mode in a case of a plain paper. In the Embodiment 1, the low speed mode corresponds to a first mode, which is the slowest image forming speed of the plurality of the modes, and the full speed mode corresponds to a second mode other than the first mode. In a case of performing the image formation in the full speed mode, from the development separated state until the development contact is completed, the control portion 202 is executing rotational control of the photosensitive drum 1, the developing roller 42 and the supplying roller 43 at this rotation speed of the low speed mode.

On the other hand, in a case of performing the image formation in the low speed mode, from the development separation to the completion of the development contact, and further until completion of the image formation, the control portion 202 is configured to perform the rotational control of the photosensitive drum 1, the developing roller 42 and the supplying roller 43 with maintaining the low speed mode. Although detail will be described below, for the widthwise streak at the supplying roller cycle, it is important to reduce an absolute speed difference between the photosensitive drum 1 and the developing roller 42 upon the development contact and an absolute speed difference between the supplying roller 43 and the developing roller 42. In a case in which each absolute speed difference during image formation has an effect on the widthwise streak at the supplying roller cycle, the low speed mode may be maintained from the development separation to the completion of the image formation. However, it is not limited thereto in a case of desiring further effect on the widthwise streak at the supplying roller cycle, but the control portion 202 may control at a slower rotation speed than the rotation speed during image formation in the low speed mode from the development separation until the development contact is completed.

On the one hand, by being rotated at the lower speed and performing the development contact, the absolute speed difference between the photosensitive drum 1 and the developing roller 42 becomes smaller, so that it becomes possible to obtain the effect on the widthwise streak at the supplying roller cycle. However, in a case in which either the photosensitive drum 1 or the developing roller 42 makes the contact with the other in a state of no rotation, the toner 90 on the developing roller 42 may become solidly fixed. Therefore in order to prevent the toner from being solidly fixed, it is desirable that the photosensitive drum 1 and the developing roller 42 be brought into contact with each other in the rotating state. In the Embodiment 1, the photosensitive drum 1 is rotated at 1 mm/sec-88 mm/sec, the developing roller 42 is rotated at 1.4 mm/sec-123 mm/sec, and the supplying roller 43 is rotated at 1.3 mm/sec-111 mm/sec, and perform the development contact. By this, improvement of the widthwise streak at the supplying roller cycle can be confirmed. Incidentally, the absolute speed difference between the photosensitive drum 1 and the developing roller 42 in this case is in a range of 0.4 mm/sec-35 mm/sec, and the absolute speed difference between the supplying roller 43 and the developing roller 42 is in a range of 0.1 mm/sec-12 mm/sec. The peripheral speed ratio between the photosensitive drum 1 and the developing roller 42 and the peripheral speed ratio of the developing roller 42 and the supplying roller 43 upon the development contact in the Embodiment 1 are the same as those during image formation, which are 1.4 times and 0.9 times, respectively.

In addition, the control portion 202 drives the driving motor 85 at the low speed (t102a) after receiving the print signal at t106, and applies the voltages of −450 V to the developing roller 42 (t113a) and −550 V to the supplying roller 43 (t114a).

In such a state, the control portion 202 performs the development contact at t107, and after the completion of the development contact (after t107), by a time when the image exposure is started by the scanner unit 3 at t108, increases the driving motor speed t102 to the full speed (t102b). By this, the control portion 202 increases the peripheral speeds of the photosensitive drum 1 (t103b), the developing roller 42 (t104b) and the supplying roller 43 (t105b) to the peripheral speeds for the image formation (full speeds). Thereafter, the control portion 202 starts the image exposure at t108 and performs the image formation during the period t109. After completion of the image exposure at t110, by performing the development separation at t111 and stopping the driving motor 85 after the development separation (t102c), the control portion 202 stops the rotation of the photosensitive drum 1 (t103c), the developing roller 42 (t104c), and the supplying roller 43 (t105c). Along with this, the control portion 202 stops the voltage application to the developing roller 42 (t113c) and the supplying roller 43 (t114c), and terminates the image formation at t112.

### Verification of Effect

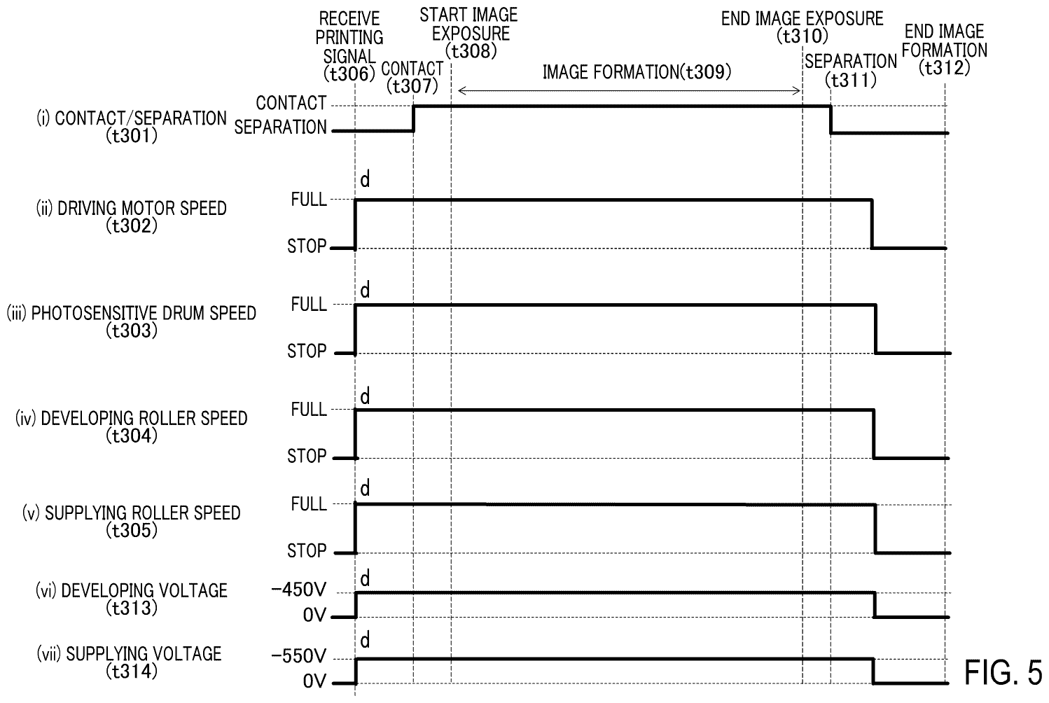

An image evaluation is performed by using the image forming apparatus 100 and the process cartridge 88 in the Embodiment 1. A sensory evaluation is performed by printing an all black image on a plain paper of A4 size under an environment of 25° C./50% RH. As a comparative example, timing charts in a Comparative Example 1 are shown in FIG. 5. Incidentally, (i) through (vii) in FIG. 5 correspond to (i) through (vii) in FIG. 4, and t301 through t314 correspond to t101 through t114. In addition, “d”s in t302 through t305, t313 and t314 indicate timings.

In the Comparative Example 1, the control portion 202 drives the driving motor 85 at the full speed (t302d) after receiving the print signal (t306). As a result, the control portion 202 drives the photosensitive drum 1 (t303d), the developing roller 42 (t304d) and the supplying roller 43 (t305d) at the full speed. In addition, after receiving the print signal (t306), the control portion 202 drives the driving motor 85 (t302d), applies the voltages of −450 V to the developing roller 42 (t313d) and −550 V to the supplying roller 43 (t314d), respectively, and performs the development contact (t307). Since the subsequent operations from the start of the image exposure (t308) to the completion of the image formation (t312) are the same as those in the Embodiment 1, description thereof will be omitted.

Table 1 shows results of the sensory evaluation on the widthwise streak at the supplying roller cycle conducted by the inventors. Symbols A, B, C and D in Table 1 (and Table 3 described later) represent A: Excellent, B: Good, C: OK and D: Bad, respectively. In other words, in Table 1, C is better in the evaluation result in the sensory evaluation than D, and A is better in the evaluation result in the sensory evaluation than B (A>B>C>D).

TABLE 1

| Embodiment 1 | Comparative Example 1 |
|---|---|
| B | D |

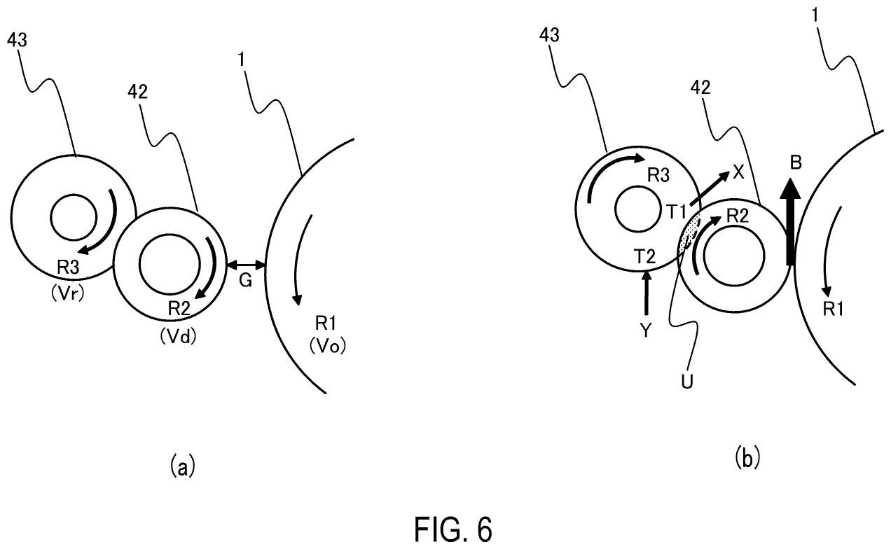

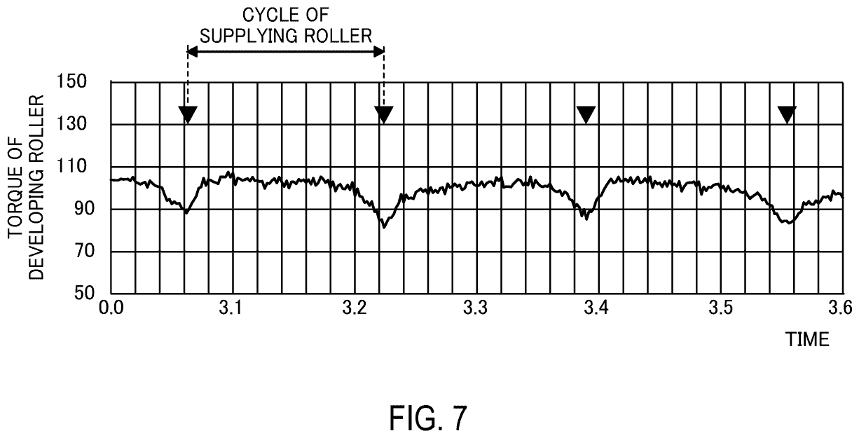

As shown in Table 1, the evaluation result is rank B in the Embodiment 1, which is superior result to rank D of the Comparative Example 1 for the generation of the widthwise streak at the supplying roller cycle. A reason for this will be described using FIG. 6 and FIG. 7.

Part (a) of FIG. 6 shows a state in which the photosensitive drum 1 and the developing roller 42 are rotationally driven in the development separation with keeping a gap G therebetween. During the development separation, the photosensitive drum 1 is rotated at the peripheral speed of Vo, the developing roller 42 is rotated at the peripheral speed of Vo, and the supplying roller 43 is rotated at the peripheral speed of Vr, respectively, and magnitudes of the peripheral speeds are in an order of Vd>Vr>Vo. Part (b) of FIG. 6 shows a state in which the photosensitive drum 1 and the developing roller 42 have performed the development contact, and for making the contact in a state in which the peripheral speed Vo of the photosensitive drum 1 and the peripheral speed Vd of the developing roller 42 are different (Vd>Vo), braking action of an arrow B is generated on the surface of the developing roller 42. If the absolute speed difference |Vo−Vd| between the peripheral speed Vo of the photosensitive drum 1 and the peripheral speed Vd of the developing roller 42 is large, kinetic energy is increased, so that the braking action is also increased.

In addition, also for the supplying roller 43, which has been rotationally driven at Vr during development separation, the peripheral speed thereof is decreased due to the braking action of the developing roller 42 upon the development contact. As described above, the supplying roller 43 repeats the deformation and the recovery of the foam layer as the developing roller 42 contacts thereto and is rotated, discharges the toner 90 in a T1 direction toward an area X, and performs absorption of the toner 90 in a T2 direction from an area Y in part (b) of FIG. 6. The larger the absolute speed difference |Vr−Vd| between the peripheral speed Vr of the supplying roller 43 and the peripheral speed Vd of the developing roller 42, the greater the kinetic energy, and thus the greater a deforming amount and a recovery amount of the foam layer. If the peripheral speed is changed in a part of a peripheral direction of the supplying roller 43, a discharging amount and an absorbing amount of the toner 90 at a position where the peripheral speed has been changed is changed, and an unevenness containing toner portion U is generated on the peripheral surface of the supplying roller 43. As a result, friction resistance unevenness on the surface of the supplying roller 43 is formed.

FIG. 7 shows torque data of the developing roller 42 in a case in which there is the unevenness containing portion U of the toner 90 on the peripheral surface of the supplying roller 43. In FIG. 7, a horizontal axis represents time and a vertical axis represents torque of the developing roller 42. In addition, “▾” indicates timings when the unevenness containing portion U of the supplying roller 43 passes through the contacting portion with the developing roller 42. As shown in a graph in FIG. 7, the torque of the developing roller 42 fluctuates due to the friction resistance unevenness when the unevenness containing portion U of the supplying roller 43 passes through the contacting portion with the developing roller 42. Because of this, the peripheral speed Vd of the developing roller 42 after the development contact fluctuates, and the widthwise streak at the supplying roller cycle is generated in an image. For the reason as described above, in the Comparative Example 1, the widthwise streak at the supplying roller cycle with the rank D in the sensory evaluation is generated.

On the other hand, in the configuration in the Embodiment 1, since the development contact is performed with making the rotational drive the low speed, it becomes possible to reduce the absolute speed difference |Vo−Vd| between the peripheral speed Vo of the photosensitive drum 1 and the peripheral speed Vd of the developing roller 42 compared to the case of contacting at the full speed. In addition, it also becomes possible to reduce the absolute speed difference |Vr−Vd| between the peripheral speed Vr of the supplying roller 43 and the peripheral speed Vd of the developing roller 42 compared to the case of contacting at the full speed. In Table 2, values of |Vo−Vd| and values of |Vr−Vd| in the Embodiment 1 and in the Comparative Example 1 are shown.

TABLE 2

| | Embodiment 1 | Comparative Example 1 |
|---|---|---|
| \|Vo − Vd\| | 20 mm/sec | 59 mm/sec |
| \|Vr − Vd\| | 7 mm/sec | 21 mm/sec |

As described above, in the Embodiment 1 above, the control portion 202 performs the following control. First, a period before the electrostatic latent image is formed on the photosensitive drum 1 (FIG. 4—t108) and until the developing roller 42 is moved from the separated position to the contacting position by the contacting and separating mechanism 50 (FIG. 4—t107) is defined as a first period. In the first period, the peripheral speed of the photosensitive drum 1 is defined as Vo1, the peripheral speed of the developing roller 42 as Vd1, and the peripheral speed of the supplying roller 43 as Vr1. In addition, in the first period, an absolute value of a difference between the peripheral speed of the photosensitive drum 1 and the peripheral speed of the developing roller 42 is defined as |Vo1−Vd1|, and an absolute value of a difference between the peripheral speed of the developing roller 42 and the peripheral speed of the supplying roller 43 is defined as |Vd1−Vr1|. In addition, a period during which the electrostatic latent image is being formed on the photosensitive drum 1 (t108-t110 in FIG. 4) is defined as a second period. In the second period, the peripheral speed of the photosensitive drum 2 is defined as Vo2, the peripheral speed of the developing roller 42 as Vd2, and the peripheral speed of the supplying roller 43 as Vr2. In addition, in the second period, an absolute value of a difference between the peripheral speed of the photosensitive drum 1 and the peripheral speed of the developing roller 42 is defined as |Vo2−Vd2|, and an absolute value of a difference between the peripheral speed of the developing roller 42 and the peripheral speed of the supplying roller 43 is defined as |Vd2−Vr2|. At this time, the control portion 202 controls the driving motor 85 so as to satisfy the following relationship,

$$\begin{matrix}\vert V o 1 - V d 1 \vert < \vert V o 2 - V d 2 \vert \\ \vert V d 1 - V r 1 \vert < \vert V d 2 - V r 2 \vert .\end{matrix}$$

In other words, the control portion 202 controls the driving motor 85 so as to monotonically change the peripheral speed of the photosensitive drum 1 from Vo1 to Vo2, the peripheral speed of the developing roller 42 from Vd1 to Vd2, and the peripheral speed of the supplying roller 43 from Vr1 to Vr2.

In addition, a ratio of the peripheral speed of the developing roller 42 to the peripheral speed of the photosensitive drum 1 is defined as Vd1/Vo1, and a ratio of the peripheral speed of the supplying roller 43 to the peripheral speed of the developing roller 42 is defined as Vr1/Vd1 in the first period. A ratio of the peripheral speed of the developing roller 42 to the peripheral speed of the photosensitive drum 1 is defined as Vd2/Vo2, and the ratio of the peripheral speed of the supplying roller 43 to the peripheral speed of the developing roller 42 as Vr2/Vd2 in the second period. At this time, the control portion 202 controls the driving motor 85 so as to satisfy the following relationship,

$$\begin{matrix}V d 1 / V o 1 = V d 2 / V o 2 \\ V r 1 / V d 1 = V r 2 / V d 2\end{matrix}$$

In addition, in terms of the modes, the control portion 202 controls the driving motor 85 so that in the first period in the case of operating in the full speed mode, the peripheral speed of the photosensitive drum 1, the peripheral speed of the developing roller 42, and the peripheral speed of the supplying roller 43 become the peripheral speeds in the low speed mode, respectively. And the control portion 202 controls the driving motor 85 so as to become the full speed mode in the second period. On the other hand, the control portion 202 controls the driving motor 85 so that in the first period in the case of operating in the low speed mode, the peripheral speed of the photosensitive drum 1, the peripheral speed of the developing roller 42, and the peripheral speed of the supplying roller 43 become the peripheral speeds in the low speed mode, and maintains the low speed mode also in the second period.

By performing the development contact with reducing the absolute speed difference |Vo−Vd| between the peripheral speed Vo of the photosensitive drum 1 and the peripheral speed Vd of the developing roller 42, it becomes possible to reduce the braking action to the developing roller 42 upon the development contact. In addition to this, since the absolute speed difference |Vr−Vd| between the peripheral speed Vr of the supplying roller 43 and the peripheral speed Vd of the developing roller 42 is also reduced, it becomes possible to reduce the deforming amount and the recovery amount of the foam layer of the supplying roller 43. By this, it becomes possible to reduce the unevenness containing the toner 90 of the peripheral surface of the supplying roller 43, and suppress the torque fluctuation in the developing roller 42. Therefore, since it becomes possible for the developing roller 42 to be rotated stably after the development contact as well, in the Embodiment 1, it becomes the rank B in the sensory evaluation, and the widthwise streak at the supplying roller cycle is improved.

As described above, in the configuration in which the photosensitive drum 1 and the developing roller 42 are separable and the developing device 4 includes the supplying roller 43 which includes the foam member in contact with the developing roller 42, by configuration as following, effects can be obtained. That is, in the Embodiment 1, the absolute speed difference between the peripheral speed of the photosensitive drum 1 and the peripheral speed of the developing roller 42 and the absolute speed difference between the peripheral speed of the supplying roller 43 and the peripheral speed of the developing roller 42 upon the development contact are configured to be smaller than those during image formation. By this, it becomes possible to improve the widthwise streak at the supplying roller cycle. By configuration in this manner, there is no need to change the peripheral speed ratio of the photosensitive drum 1 and the developing roller 42 and/or the peripheral speed ratio of the developing roller 42 and the supplying roller 43 upon the development contact. And also in the configuration in which the same driving motor 85 drives the photosensitive drum 1, the developing roller 42 and the supplying roller 43, it becomes possible to improve the widthwise streak at the supplying roller cycle.

As described above, according to the Embodiment 1, in the image forming apparatus provided with the photosensitive drum and the developing roller which are contactable with and separable from each other, it becomes possible to reduce the generation of the widthwise streak at the rotation cycle of the supplying roller which includes the foam member in contact with the developing roller.

### Embodiment 2

In an Embodiment 2, it is a configuration which controls the supplying voltage applied to the supplying roller 43 upon the development contact in the Embodiment 1 and further improves the widthwise streak at the supplying roller cycle. Incidentally, the description for the image forming apparatus 100, the process cartridge 88 and the timing chart, which are the same as those in the Embodiment 1, will be omitted.

### <Control of the Supplying Voltage Upon the Development Contact>

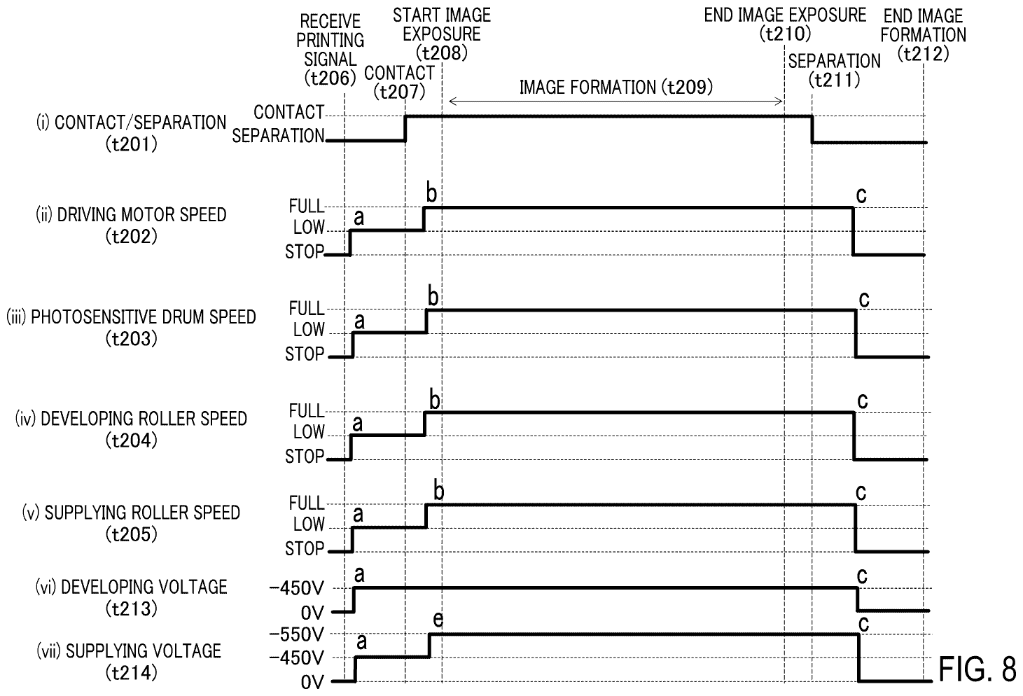

FIG. 8 shows timing charts in the present Embodiment. Incidentally, (i) through (vii) in FIG. 8 correspond to (i) through (vii) in FIG. 4, and t201 through t214 and “a” through “c” correspond to t101 through t114 and “a” through “c” in FIG. 4. Incidentally, t214e indicates a timing.

The control portion 202 drives, after receiving the print signal (t206), in the state of the development separation (t201), the driving motor 85 at the low speed (t202a). At this time, in the Embodiment 2, it is configured that the control portion 202 applies the supplying voltage of the same value as the developing voltage (−450 V) applied to the developing roller 42 to the supplying roller 43 (t214a). The control portion 202 uniformly sets, in a state in which the voltages applied to the supplying roller 43 and the developing roller 42 are set to the same, the peripheral speeds of the photosensitive drum 1 (t203a), the developing roller 42 (t204a) and the supplying roller 43 (t205a) to the low speed.

The development contact is performed in such a state, and the control portion 202 increases, after the development contact is completed (t207) and by a time when the image exposure is started by the scanner unit 3 (t208), the peripheral speed of the driving motor 85 to the full speed (t202b). By this, the control portion 202 increases the peripheral speeds of the photosensitive drum 1 (t203b), the developing roller 42 (t204b) and the supplying roller 43 (t205b) to the peripheral speeds for the image formation. In addition to this, the control portion 202 also raises the supplying voltage applied to the supplying roller 43 to −550 V (t214e). Thereafter, the control portion 202 starts the image exposure (t208) and performs the image formation (t209). Since the subsequent operations from the completion of the image exposure (t210) to the completion of the image formation (t212) are the same as those in the Embodiment 1, description thereof will be omitted.

### Verification of Effect

An image evaluation is performed by using the image forming apparatus 100 and the process cartridge 88 in the Embodiment 2. A sensory evaluation is performed by printing the all black image on the plain paper of A4 size under the environment of 25° C./50% RH. Results are shown in Table 3. Table 3 shows results of the sensory evaluation on the widthwise streak at the supplying roller cycle conducted by the inventors.

TABLE 3

| Embodiment 2 | Comparative Example 1 |
|---|---|
| A | D |

As shown in Table 3, the evaluation result is rank A in the Embodiment 2, which is superior result to rank D of the Comparative Example 1 for the generation of the widthwise streak at the supplying roller cycle. A reason for this will be described below.

The Embodiment 2 is the configuration in which the potential difference between the developing roller 42 and the supplying roller 43 upon the development contact is the same potential. Factors for the toner discharge from the supplying roller 43 include the deformation and the recovery of the foam member and the potential difference with the developing roller 42. By configuration as in the Embodiment 2, it becomes possible to eliminate the discharge of the toner 90 from the supplying roller 43 to the developing roller 42 due to the potential difference. In other words, it becomes possible to suppress a discharged amount of the toner 90 in a case in which the supplying roller 43 experiences peripheral speed fluctuation. As a result, it becomes possible to reduce the unevenness containing toner on the peripheral surface of the supplying roller 43.

In this manner, by setting the photosensitive drum 1 and the developing roller 42 to the low speed upon the development contact to reduce the absolute speed difference, and setting the developing roller 42 and the supplying roller 43 to the same potential, it becomes possible to suppress the unevenness containing toner in the supplying roller 43 upon the development contact. Therefore, since it becomes possible for the developing roller 42 to be rotated stably after the development contact as well, in the Embodiment 2, it becomes the rank A in the sensory evaluation, and the widthwise streak at the supplying roller cycle is improved. After the development contact, by raising the supplying voltage to a voltage value which results in a potential difference with which it is easier for the toner 90 to be moved from the supplying roller 43 to the developing roller 42, it becomes possible to perform the supply of the toner stably to the developing roller 42 during image formation.

Incidentally, in the Embodiment 2, it is configured that the developing roller 42 and the supplying roller 43 are set to the same potential upon the development contact. However, the control portion 202 may control the developing voltage power source 72 and the supplying voltage power source 75 so that an absolute value of the supplying voltage (see the Embodiment 1) is equal to or lower than an absolute value of the developing voltage in the first period. In other words, a potential difference which moves the toner 90 to the supplying roller 43 side may be set. For example, in the case in which the toner 90 having negative chargeability is used as in the Embodiment 2, it may be configured as following. Specifically, it may be configured that a voltage value higher on positive side than a voltage value applied to the developing roller 42 is applied to the supplying roller 43 until the development contact is made, and after the development contact, the voltage may be raised so as to be the potential difference with which it is easier for the toner 90 to be moved from the supplying roller 43 to the developing roller 42.

As described above, in the configuration in which the photosensitive drum 1 and the developing roller 42 are separable and the developing device 4 includes the supplying roller 43 which includes the foam member in contact with the developing roller 42, it is configured as following. That is, it is configured that the absolute speed difference between the peripheral speed of the photosensitive drum 1 and the peripheral speed of the developing roller 42 upon the development contact is set smaller than those during image formation, and the potential difference between the developing roller 42 and the supplying roller 43 is set so that the toner 90 is not moved from the supplying roller 43 to the developing roller 42. By this, it becomes possible to reduce the unevenness containing toner in the supplying roller 43 upon the development contact and improve the widthwise streak at the supplying roller cycle. By configuration in this manner, there is also no need to change the peripheral speed ratio of the photosensitive drum 1 and the developing roller 42 and/or the peripheral speed ratio of the developing roller 42 and the supplying roller 43 upon the development contact. Therefore also in the configuration in which the same driving motor 85 drives the photosensitive drum 1, the developing roller 42 and the supplying roller 43, it becomes possible to improve the widthwise streak at the supplying roller cycle.

As described above, according to the Embodiment 2, in the image forming apparatus provided with the photosensitive drum and the developing roller which are contactable with and separable from each other, it becomes possible to reduce the generation of the widthwise streak at the rotation cycle of the supplying roller which includes the foam member in contact with the developing roller.

### Other Embodiments

The present invention may also be realized by a process in which a program realizing one or more functions of the Embodiments described above is supplied to the system or the apparatus via a network or a storage medium, and one or more processors in a computer of the system or the apparatus read out and execute the program. In addition, the present invention may also be realized by a circuit which realizes the one or more functions (e.g., ASIC).

Disclosure of the present Embodiments includes the following constitutions.

### (Constitution 1)

An image forming apparatus comprising:
a rotatable image bearing member on which an electrostatic latent image is formed;
a rotatable developing member configured to supply a developer to the image bearing member, develop the electrostatic latent image and form a developer image;
a rotatable supplying member configured to supply the developer to the developing member by contacting the developing member;
a moving portion configured to move the developing member to a contacting position where the developing member is contacted to a surface of the image bearing member or a separated position where the developing member is separated from the surface of the image bearing member;
a driving source configured to drive the image bearing member, the developing member and the supplying member; and
a control means configured to control the moving portion and the driving source,
wherein in a first period when the developing member is moved from the separated position to the contacting position by the moving portion before the electrostatic latent image is formed on the image bearing member, when a peripheral speed that is a moving speed of a surface of the image bearing member is defined as Vo1, a peripheral speed that is the moving speed of a surface of the developing member is defined as Vd1, a peripheral speed that is a moving speed of a surface of the supplying member is defined as Vr1, an absolute value of a difference between the peripheral speed of the image bearing member and the peripheral speed of the developing member is defined as |Vo1−Vd1|, and an absolute value of a difference between the peripheral speed of the developing member and the peripheral speed of the supplying member is defined as |Vd1−Vr1|, and
in a second period while the electrostatic latent image is being formed on the image bearing member, when a peripheral speed that is a moving speed of the surface of the image bearing member is defined as Vo2, a peripheral speed that is a moving speed of the surface of the developing member is defined as Vd2, a peripheral speed that is a moving speed of the surface of the supplying member is defined as Vr2, an absolute value of a difference between the peripheral speed of the image bearing member and the peripheral speed of the developing member is defined as |Vo2−Vd2|, and an absolute value of a difference between the peripheral speed of the developing member and the peripheral speed of the supplying member is defined as |Vd2−Vr2|,
the control means controls the driving source
so as to satisfy a following relationship,

$$\begin{matrix}\vert V o 1 - V d 1 \vert < \vert V o 2 - V d 2 \vert , and \\ \vert V d 1 - V r 1 \vert < \vert V d 2 - V r 2 \vert , and\end{matrix}$$

so as to monotonically change the peripheral speed that is the moving speed of the surface of the image bearing member from Vo1 to Vo2,
the peripheral speed that is the moving speed of the surface of the developing member from Vd1 to Vd2, and
the peripheral speed that is the moving speed of the surface of the supplying member from Vr1 to Vr2.

### (Constitution 2)

The image forming apparatus according to Constitution 1, wherein when a ratio of the peripheral speed of the developing member to the peripheral speed of the image bearing member is defined as Vd1/Vo1 and a ratio of the peripheral speed of the supplying member to the peripheral speed of the developing member is defined as Vr1/Vd1 in the first period, and
a ratio of the peripheral speed of the developing member to the peripheral speed of the image bearing member is defined as Vd2/Vo2 and a ratio of the peripheral speed of the supplying member to the peripheral speed of the developing member is defined as Vr2/Vd2 in the second period,
the control means controls the driving source so as to satisfy a following relationship,

$$\begin{matrix}V d 1 / V o 1 = V d 2 / V o 2 , and \\ V r 1 / V d 1 = V r 2 / V d 2.\end{matrix}$$

### (Constitution 3)

The image forming apparatus according to Constitution 1 or Constitution 2, further comprising:
a developing voltage applying means configured to apply a developing voltage to the developing member; and
a supplying voltage applying means configured to apply a supplying voltage to the supplying member,
wherein the control means controls the developing voltage applying means and the supplying voltage applying means so that an absolute value of the supplying voltage in the first period is equal to or lower than an absolute value of the developing voltage in the first period.

### (Constitution 4)

The image forming apparatus according to any one of Constitution 1 to Constitution 3, further comprising:
a charging member configured to charge the image bearing member before the electrostatic latent image is formed; and
a transfer member configured to transfer the developer image to a transferred member,
wherein when a polarity of the developer is defined as a normal polarity,
the charging member charges the developer, remaining on the surface of the image bearing member after the developer image is transferred to the transferred member by the transfer member, to the normal polarity, and
the developing member collects the developer charged to the normal polarity by the charging member.

### (Constitution 5)

The image forming apparatus according to any one of Constitution 1 to Constitution 4, wherein the image forming apparatus is capable of performing image formation in a plurality of modes with different image forming speeds, and
wherein when a first mode is a mode with the lowest image forming speed of the plurality of modes and a second mode is a mode other than the first mode,
the control means controls the driving source so that in the first period in case of performing in the second mode, the peripheral speed of the image bearing member, the peripheral speed of the developing member and the peripheral speed of the supplying member become a peripheral speed in the first mode, and so that in the first period in case of performing in the first mode, the peripheral speed of the image bearing member, the peripheral speed of the developing member and the peripheral speed of the supplying member become the peripheral speed in the first mode.

### (Constitution 6)

The image forming apparatus according to any one of Constitution 1 to Constitution 5, wherein the image bearing member is rotated in a first direction, and
wherein the developing member and the supplying member are rotated in a second direction opposite to the first direction.

### (Constitution 7)

The image forming apparatus according to any one of Constitution 1 to Constitution 6, wherein the control means controls the driving source so as to satisfy a following relationship,

$$V d 1 > V r 1 > V o 1 or V d 2 > V r 2 > V o 2.$$

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-152752, filed on Sep. 4, 2024, which is hereby incorporated by reference herein in its entirety.

What is claimed is:

1. An image forming apparatus comprising:
a rotatable image bearing member on which an electrostatic latent image is formed;
a rotatable developing member configured to supply a developer to the image bearing member, develop the electrostatic latent image and form a developer image;
a rotatable supplying member configured to supply the developer to the developing member by contacting the developing member;
a moving portion configured to move the developing member to a contacting position where the developing member is contacted to a surface of the image bearing member or a separated position where the developing member is separated from the surface of the image bearing member;
a driving source configured to drive the image bearing member, the developing member and the supplying member; and
a control means configured to control the moving portion and the driving source,
wherein in a first period when the developing member is moved from the separated position to the contacting position by the moving portion before the electrostatic latent image is formed on the image bearing member, when a peripheral speed that is a moving speed of the surface of the image bearing member is defined as Vo1, a peripheral speed that is a moving speed of a surface of the developing member is defined as Vd1, a peripheral speed that is a moving speed of a surface of the supplying member is defined as Vr1, an absolute value of a difference between the peripheral speed of the image bearing member and the peripheral speed of the developing member is defined as |Vo1−Vd1|, and an absolute value of a difference between the peripheral speed of the developing member and the peripheral speed of the supplying member is defined as |Vd1−Vr1|, and
in a second period while the electrostatic latent image is being formed on the image bearing member, when a peripheral speed that is a moving speed of the surface of the image bearing member is defined as Vo2, a peripheral speed that is a moving speed of the surface of the developing member is defined as Vd2, a peripheral speed that is a moving speed of the surface of the supplying member is defined as Vr2, an absolute value of a difference between the peripheral speed of the image bearing member and the peripheral speed of the developing member is defined as |Vo2−Vd2|, and an absolute value of a difference between the peripheral speed of the developing member and the peripheral speed of the supplying member is defined as |Vd2−Vr2|,
the control means controls the driving source so as to satisfy a following relationship,
$$\begin{matrix}\vert V o 1 - V d 1 \vert < \vert V o 2 - V d 2 \vert , and \\ \vert V d 1 - V r 1 \vert < \vert V d 2 - V r 2 \vert , and\end{matrix}$$
so as to monotonically change the peripheral speed that is the moving speed of the surface of the image bearing member from Vo1 to Vo2, the peripheral speed that is the moving speed of the surface of the developing member from Vd1 to Vd2, and the peripheral speed that is the moving speed of the surface of the supplying member from Vr1 to Vr2.

2. The image forming apparatus according to claim 1, wherein when a ratio of the peripheral speed of the developing member to the peripheral speed of the image bearing member is defined as Vd1/Vo1 and a ratio of the peripheral speed of the supplying member to the peripheral speed of the developing member is defined as Vr1/Vd1 in the first period, and
a ratio of the peripheral speed of the developing member to the peripheral speed of the image bearing member is defined as Vd2/Vo2 and a ratio of the peripheral speed of the supplying member to the peripheral speed of the developing member is defined as Vr2/Vd2 in the second period,
the control means controls the driving source so as to satisfy a following relationship,
$$\begin{matrix}V d 1 / V o 1 = V d 2 / V o 2 , and \\ V r 1 / V d 1 = V r 2 / V d 2.\end{matrix}$$

3. The image forming apparatus according to claim 1, further comprising:
a developing voltage applying means configured to apply a developing voltage to the developing member; and
a supplying voltage applying means configured to apply a supplying voltage to the supplying member,
wherein the control means controls the developing voltage applying means and the supplying voltage applying means so that an absolute value of the supplying voltage in the first period is equal to or lower than an absolute value of the developing voltage in the first period.

4. The image forming apparatus according to claim 1, further comprising:
a charging member configured to charge the image bearing member before the electrostatic latent image is formed; and
a transfer member configured to transfer the developer image to a transferred member,
wherein when a polarity of the developer is defined as a normal polarity,
the charging member charges the developer, remaining on the surface of the image bearing member after the developer image is transferred to the transferred member by the transfer member, to the normal polarity, and
the developing member collects the developer charged to the normal polarity by the charging member.

5. The image forming apparatus according to claim 1, wherein the image forming apparatus is capable of performing image formation in a plurality of modes with different image forming speeds, and
wherein when a first mode is a mode with the lowest image forming speed of the plurality of modes and a second mode is a mode other than the first mode,
the control means controls the driving source so that in the first period in a case of performing the image formation in the second mode, the peripheral speed of the image bearing member, the peripheral speed of the developing member and the peripheral speed of the supplying member become a peripheral speed in the first mode, and so that in the first period in a case of performing in the first mode, the peripheral speed of the image bearing member, the peripheral speed of the developing member and the peripheral speed of the supplying member become the peripheral speed in the first mode.

6. The image forming apparatus according to claim 1, wherein the image bearing member is rotated in a first direction, and
wherein the developing member and the supplying member are rotated in a second direction opposite to the first direction.

7. The image forming apparatus according to claim 1, wherein the control means controls the driving source so as to satisfy a following relationship,
$$V d 1 > V r 1 > V o 1 or V d 2 > V r 2 > V o 2.$$
